(19) United States
(12) Patent Application Publication
(10) Pub. No.: US 2008/0174486 A1
(43) Pub. Date: Jul. 24, 2008

(54) Intelligent help-requesting apparatus for the GPS

(76) Inventor: Hung-Fu Lee, Banchiau City (TW)

Correspondence Address: TROXELL LAW OFFICE PLLC, SUITE 1404, 5205 LEESBURG PIKE, FALLS CHURCH, VA, 22041, US

(21) Appl. No.: 11/655,285

(22) Filed: Jan. 19, 2007

(51) Int. Cl. G01S 5/14; G01S 1/02

(52) U.S. Cl. 342/357.07; 342/357.09

(57) ABSTRACT

The present invention employs speed sensing module for sensing the occurring of the abnormal acceleration and automatically conveying such message to internal process unit of intelligent satellite positioning apparatus, said process unit also simultaneously receiving the positioning signal from satellite positioning receiving module and transmitting it to the server of telecommunications provider via communication module then relaying to liaison-party as well; meanwhile, said process unit also sends the speed abnormal error-alerting message together along with the positioning signal to remote server, where said positioning signal being converted into E-map or short message mode thereat, via network module; then, all these messages are relayed to liaison-party via the Internet; thus, the present invention enables liaison-party not only receive the message from telecommunications provider but also receive the network message and positioning message from remote server so as to quickly handle it effectively.

### BACKGROUND OF THE INVENTION

(a) Field of the Invention

The present invention relates to an intelligent help-requesting apparatus for the GPS (Global Positioning System), particularly to one via the internal speed sensing module for immediately sensing the happening of abnormal speed and intuitively feedback so as to achieve the intelligent help-requesting function.

(b) Description of the Prior Art

Following along with gradual maturity of the Global Positioning System (GPS), the domestic tourism becomes in ardent demand and pays much more attention to the concept of the traveling safety and insurance, and the application of the GPS-based vehicle navigation also becomes more popular; hence the new relevant electronic products of the vehicle navigation emerge constantly to obsolete the old ones in the market; thereby, the GPS is rapidly improved into better accurate and speedy function to achieve the effective performance of the positioning navigation.

Rather than the vehicle navigation, the GPS is also applied in the vehicle theft-proof system.

After switching on the vehicle theft-proof system, if any abnormal movement happens onto the aimed vehicle, the internal communication system thereof will immediately transmit the GPS positioning signal to the cellular phone of the vehicle owner so that the vehicle owner can receive the error-alerting signal within short time for checking and handling; Thus, the applicable range and territory of GPS is extensively increased. However, after removing the setting on the vehicle theft-proof system, if any the aimed vehicle is invaded, the system will not provide any error-alerting signal for informing the vehicle owner.

Besides, the GPS can also be applied in the positioning tracking for the children or the aged people so that whose family people can effectively know well his/her tracks in order to greatly reduce the stray rate. Currently, the GPS possesses foregoing uses, but it can not effectively and intelligently send out a help-requesting signal in danger, for example of vehicle being collided, the driver can probably not move any more or in a coma unable to correspond outside world during first aid time so that the GPS unfortunately fails the help-requesting function with barely remaining inadequate referential and guiding use.

In view of the foregoing drawbacks in the conventional GPS, the inventor of the present invention is eager to innovatively improve it by elaborately research and study; finally, the intelligent help-requesting apparatus for the GPS in the present invention is successfully accomplished as disclosed.

### SUMMARY OF THE INVENTION

The intelligent help-requesting apparatus for the GPS (Global Positioning System) in the present invention comprises:

a satellite positioning receiving module is configured to capture the signal form the satellite for spotting the location thereof, and then relay the positioning signal to the process unit;
a process unit is not only to receive the information from said satellite positioning receiving module but also to serve as the processing center for following speed sensing module, communication module and network module, then effectively transmit the received information to each module respectively;
a speed sensing module is configured for sensing the happening of the abnormal acceleration such as dropping, impacting, colliding, movement and the like of instantaneous acceleration to produce an error-alerting signal to said process unit thereat so as to transmit to other modules;
a communication module is for receiving the signal from said process unit and relay it to the server of the telecommunications provider so that the positioning signal can be transmitted to the predetermined liaison-party via said telecommunications provider for providing the instant information; and
a network module is for receiving the signal from said process unit and relaying it to the remote server so that the positioning signal can be converted into E-map or short message thereat in order to pass such information and provide the more accurate information to the predetermined liaison-party via said remote server.

The intelligent help-requesting apparatus for the GPS of the present invention can be used in the vehicle or person that the internal speed sensing module immediately senses the happening of abnormal acceleration and transmits the error-alerting signal to the (process unit) whenever the impact or collision of the vehicle or the pedestrian tumble; at the same time, the process unit not only receives the positioning signal from said satellite positioning receiving module but also transmits it to the server of the telecommunications provider via the communication module so that said telecommunications provider can relay the positioning signal to the predetermined liaison-party by means of short message mode; meanwhile, the process unit transmits the positioning signal to the remote server and being converted and displayed in E-map or short message mode thereat via network module, then relays the converted E-map or short message to the predetermined liaison-party via Internet so that said liaison-party definitely acquires the certain location of the intelligent satellite positioning apparatus; At this moment, said liaison-party can initiatively response dialogue with the holder of the intelligent satellite positioning apparatus to confirm the status or to dial a call to the emergency relieving organization for tri-parties dialogue in case of no response therefrom so as to substantially enhance the practicality in benefit of the relieving instantaneity and convenience.

The main object of the present invention is to provide an intelligent help-requesting apparatus for the GPS by means of the internal speed sensing module for immediately sensing the happening of abnormal speed and initiatively feedback so as to achieve the intelligent help-requesting function.

The next object of the present invention is to provide an intelligent help-requesting apparatus for the GPS by means of the cooperation in the network module and the remote server for relaying the positioning message of E-map or short message mode to the predetermined liaison-party via the Internet.

The further object of the present invention is to provide an intelligent help-requesting apparatus for the GPS by means of the cooperation in the network module and the remote server for relaying the positioning message of E-map or short message mode to the predetermined liaison-party via the Internet.

Another object of the present invention is to provide an intelligent help-requesting apparatus for the GPS by the internal communication module means of relaying the positioning message to the server of the telecommunications provider so that said telecommunications provider can proceed the tri-parties dialogue with the predetermined liaison-party and the emergency relieving organization.

The other object of the present invention is to provide an intelligent help-requesting apparatus for the GPS with multiple advantages of easy and simple operation

### BRIEF DESCRIPTION OF THE DRAWINGS

FIG. 1 is an illustrative block diagram showing the intelligent help-requesting apparatus for the GPS (Global Positioning System) in the present invention.

FIG. 2 is an illustrative block diagram showing the system transmission and connection of the intelligent help-requesting apparatus for the GPS in the present invention.

FIG. 3 is an illustrative block diagram showing tri-parties dialogue of the intelligent help-requesting apparatus for the GPS in the present invention.

FIG. 4 is an illustrative block diagram showing perspective structure of the intelligent help-requesting apparatus for the GPS in the present invention.

### DETAILED DESCRIPTION OF THE PREFERRED EMBODIMENTS

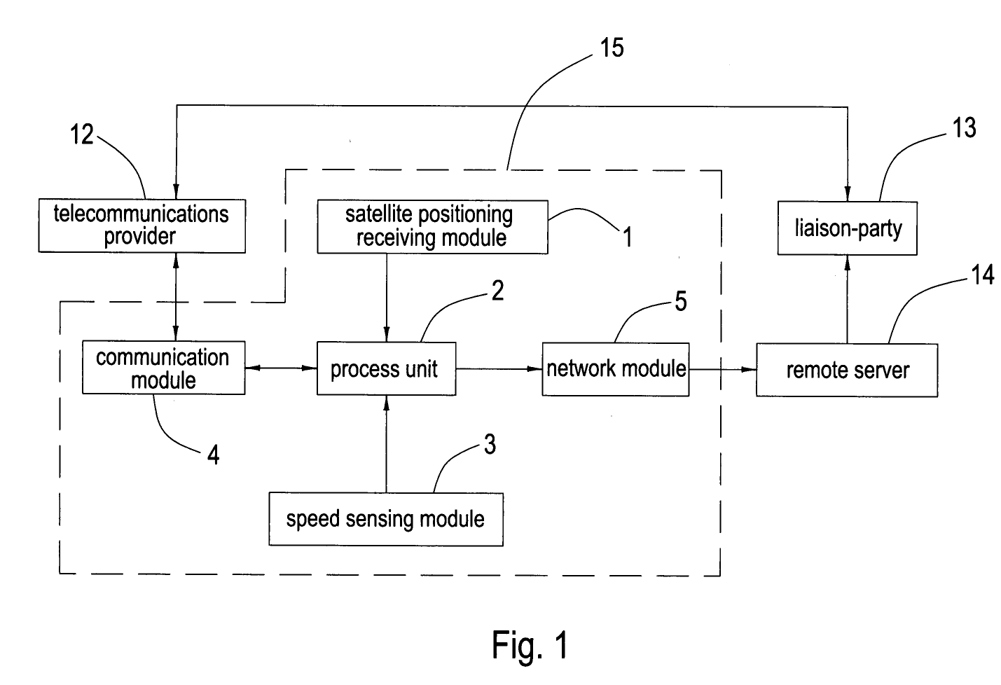

Please refer to FIG. 1, the illustrative block diagram showing the intelligent help-requesting apparatus for the GPS (Global Positioning System) in the present invention comprises:

a satellite positioning receiving module 1, which can be either SiRF (SiRF is a brand of microcontroller designed to be used with GPS systems) or other chips such as GPS, is configured to capture the signal form the satellite 11 for spotting the location thereof, and then relay the positioning signal to the process unit 2;
a process unit 2 is not only to receive the information from said satellite positioning receiving module 1 but also to serve as the processing center for following speed sensing module 3, communication module 4 and network module 5, then effectively transmit the received information to each module respectively;
a speed sensing module 3 is configured for sensing the happening of the abnormal acceleration such as dropping, impacting, colliding, movement and the like of instantaneous acceleration to produce an error-alerting signal to said process unit 2 thereat so as to transmit to other modules;
a communication module 4, which can be anyone of GSM (Global System for Mobile Communications) module, CDMA (Code-Division Multiple Access/handsets) module, PHS (Personal Handy-phone System) module or satellite communication module, is for receiving the signal from said (process unit 2 and relay it to the server of the telecommunications provider 12 so that the positioning signal can be transmitted to the predetermined liaison-party 13 via the server of said telecommunications provider 12 for providing the instant information; and
a network module 5 is for receiving the signal from said process unit 2 and relaying it to the remote server 14 so that the positioning signal can be converted into E-map or short message thereat in order to pass such information and provide the more accurate information to the predetermined liaison-party 13 via said remote server 14.

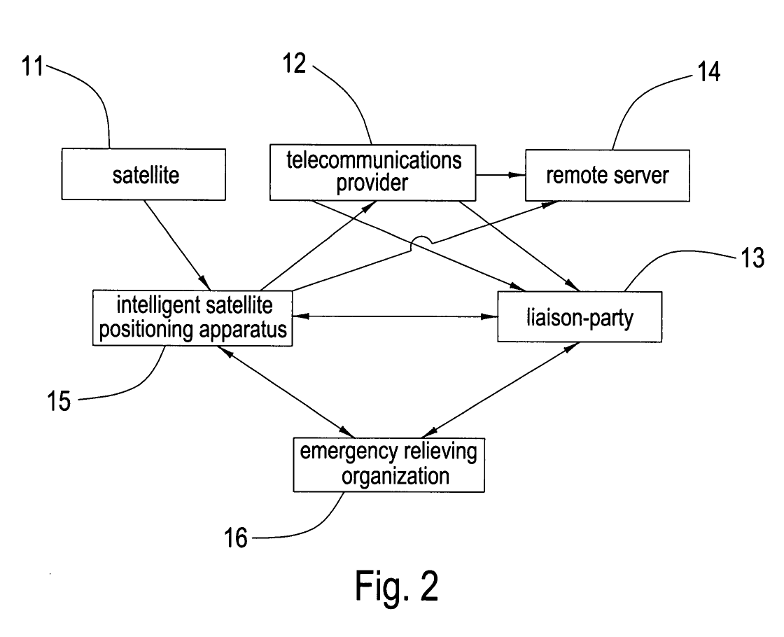

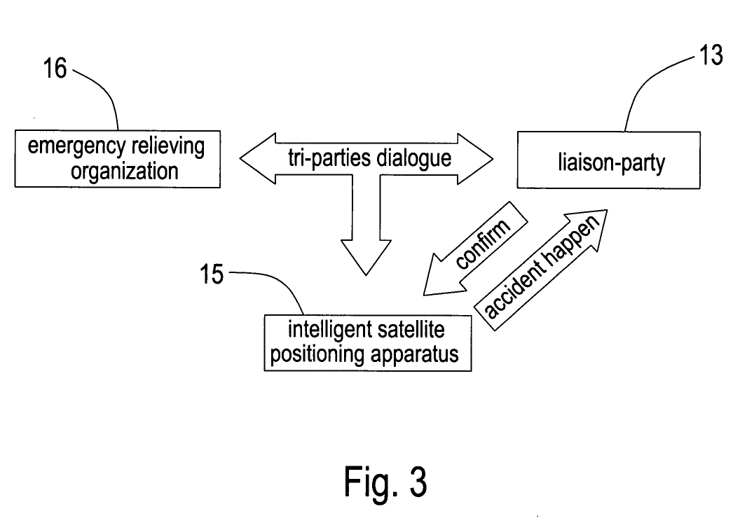

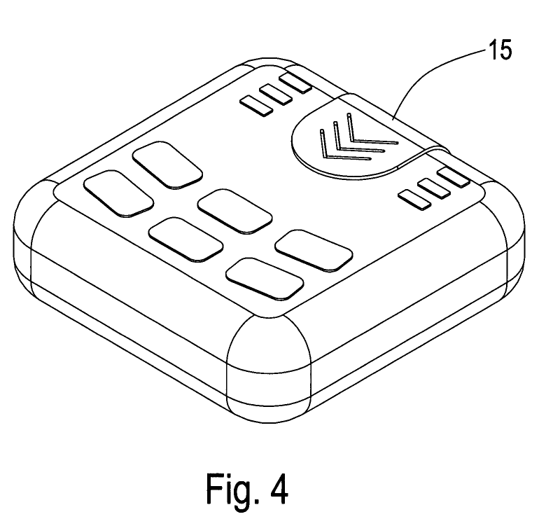

Please refer to FIG. 2 through FIG. 4, the illustrative block diagrams showing the system transmission and connection, tri-parties dialogue as well as perspective structure of the intelligent help-requesting apparatus for the GPS in the present invention.

The intelligent help-requesting apparatus for the GPS of the present invention can be used in the moving vehicle, theft-resistance of the vehicle or person that the internal speed sensing module 3 immediately senses the happening of abnormal acceleration and transmits the error-alerting signal to the process unit 2 whenever the impact or collision of the vehicle or the pedestrian tumble;

At the same time, the process unit 2 not only receives the positioning signal from said satellite positioning receiving module 1 but also transmits it to the server of the telecommunications provider 12 via the communication module 4 so that said telecommunications provider 12 can relay the positioning signal to the predetermined liaison-party 13 by means of short message mode; meanwhile, the process unit 2 transmits the positioning signal to the remote server 14 and being converted and displayed in E-map or short message mode thereat via network module 5, then relays the converted E-map or short message to the predetermined liaison-party 13 via Internet so that said liaison-party 13 definitely acquires the certain location of the intelligent satellite positioning apparatus 15; at this moment, said liaison-party 13 can initiatively response dialogue with the holder of the intelligent satellite positioning apparatus 15 to confirm the status or to dial a call to the emergency relieving organization 16 for tri-parties dialogue in case of no response therefrom so as to substantially enhance the practicality in benefit of the relieving instantaneity and convenience; wherein, said liaison-party 13 can be assigned at least one person to effectively avoid the lapse or miss of the information.

All the detailed disclosure hereinbefore is a concrete description for one specific feasible exemplary preferred embodiment of the present invention only, and said embodiment is not to limit the claims of the present invention; any equivalent embodiment, or change, modification and refinement, which does not depart from the art spirit and scope of the present invention, is intended be covered by the claims of the present invention.

1. An intelligent help-requesting apparatus for GPS (Global Positioning System) comprises:
a satellite positioning receiving module configured to capture a positioning signal form the satellite and then relay the positioning signal to a process unit;
the process unit receiving information from said satellite positioning receiving module and serving as the processing center for a speed sensing module a communication module and a network module, then effectively transmitting the received information to each module respectively;
the speed sensing module configured for sensing the happening of the abnormal acceleration by detecting instantaneous acceleration to produce an error-alerting signal to said process unit;
the communication module for receiving the signal from said process unit and relaying it to a remote server of a telecommunications provider so that the positioning signal is transmitted to a predetermined liaison-party via said telecommunications provider; and
the network module for receiving the positioning signal from said process unit and relaying it to the remote server so that the positioning signal is converted into an electronic map or a short message in order to pass the information to the predetermined liaison-party via said remote server.

2. The intelligent help-requesting apparatus for the GPS as recited in the claim 1, wherein, said satellite positioning receiving module is a SiRE microcontroller.

3. The intelligent help-requesting apparatus for the GPS as recited in the claim 1, wherein, said communication module is a GSM (Global System for Mobile Communications) or CDMA (Code-division Multiple Access/handsets) module.

4. The intelligent help-requesting apparatus for the GPS as recited in the claim 1, wherein, said communication module is a PHS (Personal Handy-phone System) module.

5. The intelligent help-requesting apparatus for the GPS as recited in the claim 1, wherein, said liaison-party is assigned one person.
